(19) United States
(12) Patent Application Publication
(10) Pub. No.: US 2017/0278025 A1
(43) Pub. Date: Sep. 28, 2017

(54) ENERGY MANAGEMENT METHOD, ENERGY MANAGEMENT DEVICE, SWITCHING DEVICE FOR AN ENERGY MANAGEMENT DEVICE, AND COMPUTER SOFTWARE PRODUCT

(71) Applicant: SIEMENTS AKTIENGESELLSCHAFT, München, (DE)

(72) Inventors: Dominic Buchstaller, Röttenbach (DE); Nader Halmuschi, Oberlungwitz (DE); Frank Jungnickel, Bräuningshof / Langensendelbach (DE); Johannes Reinschke, Nürnberg (DE); Jochen Ziegner, Leinburg (DE)

(21) Appl. No.: 15/504,753

(22) PCT Filed: Aug. 3, 2015
(86) PCT No.: PCT/EP2015/067778

§ 371 Date: Feb. 17, 2017

(30) Foreign Application Priority Data
Aug. 25, 2014 (DE) 10 2014 216 822.8

(51) Int. Cl. G06Q 10/04; H02J 13/00; G06Q 50/06

(52) U.S. Cl. CPC G06Q 10/04; G06Q 50/06; H02J 13/0086

(57) ABSTRACT

An energy management method is provided for detecting an energy consumption of at least one consumer connected to an energy supply network, wherein relevant detection values of each energy consumption are detected by a plurality of detection devices and/or calculated from detected values. A switching device is respectively assigned to at least one of the detection devices and/or at least one group of the detection devices. The detection values detected and/or calculated by the detection device and/or the group of detection devices are each provided to the switching device according to a predefined detection device protocol for the detection device and/or the group of detection devices. The respective energy values are transmitted to a central device via a network which connects the central device to all switching devices, according to a predefined central device protocol which differs from the detection device protocol.

The present patent document is a §371 nationalization of PCT Application Serial Number PCT/EP2015/067778, filed Aug. 3, 2015, designating the United States, which is hereby incorporated by reference, and this patent document also claims the benefit of DE 10 2014 216 822.8, filed Aug. 25, 2014, which is also hereby incorporated by reference.

### TECHNICAL FIELD

The disclosure relates to an energy management method for detecting an energy consumption of at least one consumer connected to an energy supply network, wherein the sum of the maximum power consumptions of all the consumers is at least 5 kW, wherein detection values relating to one energy consumption in each case are detected and/or calculated by a plurality of detection devices, after which at least parts of the detection values and/or values calculated from at least parts of the detection values are transmitted as energy values to a central device and stored there and/or evaluated. In addition, the disclosure relates to a switching device for an energy management device, an energy management device, and a computer program.

### BACKGROUND

In times of increasing environmental awareness and increasing energy prices, energy management, (e.g., the optimization and adaptation of an energy consumption of technical installations), is becoming increasingly important. If a plurality of consumers is used, potentials for saving for energy consumption are frequently given or energy consumption may be weighed up with other factors. However, these potentials for saving and optimization are frequently not possible without a precise knowledge of consumption profiles of consumers and a detailed data evaluation. The analysis of consumption data for potentials for optimization and saving may be made either by the operator of the consumers themselves or the analysis may be carried out by an external service provider, who provides experience and technical knowledge with regard to energy management. In both cases, it is necessary to have detailed information about the energy consumption of the consumers in various operating situations.

Two approaches are used to detect the energy consumption of complex consumer combinations. In large industrial installations, a process automation system or a process control system is frequently provided, which may be expanded with an integrated energy management system. In smaller industrial installations or buildings however, frequently no process automation or process control system is provided. Depending on how the specific consumer infrastructure is configured, possibly only fractions of the functional scope of a process automation or process control system may be used, which is why the technical and financial expenditure for installing such a system is not expedient in all consumer combinations.

Alternatively, special solutions may be provided, which provide special sensors that communicate with a central device. These special solutions are technically very complex, e.g., a retrofitting of suitably adapted sensors in existing consumer combinations.

### SUMMARY AND DESCRIPTION

The scope of the present disclosure is defined solely by the appended claims and is not affected to any degree by the statements within this summary. The present embodiments may obviate one or more of the drawbacks or limitations in the related art.

It is therefore the object of the disclosure to provide an energy management method that facilitates the detection of an energy consumption compared with this and may be used with lower technical expenditure in new and/or existing consumer combinations.

The object is solved by a method of the type mentioned initially, wherein at least one of the detection devices and/or at least one group of detection devices is each assigned a switching device. The detection values detected and/or calculated by the detection device and/or the group of detection devices are each provided to the switching device according to a detection-device-side protocol predefined for the detection device and/or the group of detection devices. Afterwards, the respective energy values are transmitted to the central device via a network connecting the central device to all the switching devices, according to a predefined central-device-side protocol that differs from the detection-device-side protocol.

It is proposed to use additional switching devices in addition to a central device to provide energy values to the central device. In the case of consumers, information about the consumption of an individual consumer or about consumption-determining quantities for an individual consumer is frequently already available. For example, current converters frequently already detect measured values of the currents and voltages which they provide. Also, for different types of energy transport, (e.g., for gas flows, oil flows, steam flows, flows of compressed air, or flows of cooling liquids), individual quantities are frequently provided by sensors, which are provided in any case, from which a detection value describing an energy consumption may be obtained directly or with the aid of additional information. In addition, an energy consumption may be derived partially directly or using additional measured values from control variables, which are provided by control devices.

The problem is that corresponding quantities are frequently only present locally and different consumers or different components assigned to an individual consumer, such as different sensors, communicate in different ways. Information may be transmitted as analog signals, via various bus systems such as a modbus or an I2C bus, various wired or wireless networks, as pulse-width modulated signals or similar. In order to be able to provide energy values of the consumers to a central device with low technical expenditure, it is proposed to use a switching device as an abstraction layer, which receives detection values provided with a detection-device-side protocol and provides them or values calculated from them with a central-device-side protocol to the central device. It is thus made possible that almost any information sources in the consumer combination may be used as part of the energy management, and almost any additional sensors may be used for energy detection tasks.

In the energy management method, the energy consumption may be detected separately for different regions of a building or for different regions of technical installations or equipment. The central device may be used exclusively for storing the energy values. Additionally, or alternatively, evaluation functions may be provided by the central device itself, which may enable a statistical evaluation of the energy consumption. Stored and/or evaluated energy values may be provided to further devices, for example, via an encrypted, Internet connection.

The evaluation of the energy values may be made, for example, on computers of a firm's network, via which the computers are connected to the central device or by a service provider, which may communicate via a virtual private network with the central device. In principle, it is also possible that the central device itself or further devices communicating with the central device provides control functions for individual or all consumers.

The method may be used for energy management in industrial installations, buildings or parts of buildings such as salesrooms or apartments. All or parts of the consumers may also be arranged freely in the field, on supply lines, in and/or on buildings, and/or on sea- and/or airborne equipment. An energy consumption may be detected for a plurality of different energy forms. For example, an electrical consumption, a flow of gaseous and/or of liquid chemical energy carriers, a flow of additional energy carriers such as compressed air or steam, and/or a flow of cooling liquid may be detected as detection parameters. Energy values of all consumers inside a building, an industrial installation, or another consumer combination may be detected, e.g., both the consumption of production machines of an industrial installation and also an energy consumption for heating or air-conditioning of the rooms of the industrial installation. Alternatively, only parts of the consumers may be taken into account. The method makes it possible to detect the consumption of high-power consumers and complex consumer combinations. The sum of the maximum power consumptions of all consumers is greater than 5 kW. The maximum power consumption of a consumer is understood to be that power consumption, which is the maximum used in normal operation of a consumer or which may be used by the consumer without any damage to the consumer for fairly long time intervals, for example, several minutes.

A detection device in the method may be any device that detects detection values. The detection device may include a measuring device. Dedicated measuring devices may be used, but measured quantities, which occur during operation of a consumer in any case, may also be detected. In addition, it is possible that a detection device detects quantities from which an energy consumption may be calculated. For example, a rotational speed of the machine may be detected from which a power of the machine may be determined for a known load.

In this case, it is possible that a detected measured quantity, (e.g., the rotational speed), is provided to the switching device, but a detection value derived from the detected quantity, (e.g., an energy consumption or a power), may also be calculated already in the detection device itself. Other values, (e.g., values of a control protocol), may also be detected as detection values or taken into account when calculating the detection values. For example, a detection device may be assigned to a simulation device that predicts the energy consumption of at least one consumer merely from control variables.

It is not necessary to provide a separate switching device for each detection device. For example, a plurality of detection devices may be connected to a bus, (e.g., a Modbus), via which detection values are provided.

A group of detection devices is to be understood as a subgroup of detection devices including less than all the detection devices. In the method, several groups of detection devices may be used, to which respectively one switching device is assigned. Alternatively, for example, only one group may be used, which is supplemented by several individual detection devices, to which respectively one separate switching device is assigned. In the method, the switching device may be a structural unit configured separately from the central device and the detection device, which is disposed in a separate housing.

It is possible that individual detection devices are configured to communicate via the central-device-side protocol. In this case, in the energy management method, it is not necessary to provide a switching device for these detection devices.

The energy management method may thus be implemented in a mixed system in which at least one of the detection devices communicates indirectly via the switching device with the central device and at least one additional one of the detection devices communicates directly with the central device via the central-device-side protocol.

The provision of the detection values to the switching device may be accomplished via at least one signal line in each case. The detection values may be provided in analog or digital form. A data bit may be used for communication, for which however in particular no higher functions, (e.g., a routing of data packets), are seen. The communication of the switching device with the central device may be accomplished in a wired manner, wherein a connection separate from the signal line may be used, or in a wireless manner. A wired connection may be made via Ethernet, and a wireless connection may be made via WLAN or ISA100. The network, which connects the central device to all the switching devices, may also include a plurality of network segments. It is possible that some of the connections in the network are wireless and some of the connections are wired.

The detection-device-side protocol may be both a protocol for digital signal transmission and a protocol for analog signal transmission. Protocols for analog signal transmission may specify electrical specifications of the connection, an assignment of voltages and values, and a voltage range of the signal transmission. As will be explained subsequently in further detail, it is advantageous if the central-device-side protocol enables an extensive abstraction of the individual functions of the detection devices. The switching device and the assigned detection devices may be addressable by function calls via the network or they may be mapped as “objects” in a network, which have properties, which may be accessed via the network. A corresponding functionality is, for example, provided by the protocols OPC Unified Architectures or Bacnet. Alternatively, for example, Profinet may be used as protocol. The central-device-side protocol may, however, also be a protocol specially specified to provide an energy bus on which energy values are exchanged. For example, the functionality of a central-device-side protocol may be implemented by network function calls, for example, by simple object access protocol (SOAP).

The central device may be installed on site, (e.g., in or on the building). The central device may include an industrial PC. The central device may detect a time-resolved consumption profile. In addition, further consumption-relevant parameters, for example, an idle power, may be detected.

The switching device may be exclusively used on the one hand for receiving the detection values and/or for calculating the values calculated from the detection values and on the other hand for transmitting the respective energy values to the central device. It is possible that no control tasks are performed by the switching device. In this case, the switching device may have a particularly simple structure. The switching device may be particularly inexpensive and particularly low-maintenance, e.g., if no further processing of the detection values is performed by the switching device but these are provided directly as energy values. If sufficiently large buffers are provided for data detection or provision, e.g., no real-time capability of the switching device is required. The transmission of the respective energy values may include a buffering of the energy values or the received detection values or the calculated values and/or the accumulation of data with additional functions relating to the switching device and/or the respective detection device.

At least two switching devices may be used, to which detection values with detection-device-side protocols are provided, which are different from one another. The method thus enables the combining of detection values from different buses, networks, or similar.

Functions retrievable via the network may be implemented by the central device and/or by the switching device. The functions retrievable via the network may include network-retrievable functions, which may be addressable via SOAP. The implementation of retrievable functions may also be accomplished within the framework of a predefined central-device-side protocol. For example, Bacnet supports function calls. OPC Unified Architectures assigns properties to objects in the network, on which read and write accesses are possible. Corresponding read and write accesses correspond to functions retrievable via the network. Profinet also provides an input and output functionality, which may be implemented by functions retrievable via the network.

An identification request may be transmitted to all switching devices connected to the network by the central device at predefined times, whereby an identification function implemented by the respective switching device is executed, by which an identification dataset describing the respective switching device and/or the detection device or group of detection devices assigned to the respective switching device is transmitted to the central device. By using an identification request or an identification function, automatic configuration functions of the network, which connect the central device to all the switching devices, may be provided. All connected switching devices respond to an identification request and transmit relevant data to the central device. Before a connection of a switching device, a configuration of the switching device may be performed and parameters relating to the switching device or assigned detection devices may be stored by the switching device, which are transmitted to the central device as part of the identification dataset.

An automatic network configuration is alternatively or additionally also possible whereby individual switching devices “search” for the switching device upon a first connection to the network. A switching device may transmit a broadcast into the network, (e.g., a message to a predefined address), which may be received by all network participants. As a result of this broadcast, the central device identifies that a switching device has been connected to the network and may call up the identification function, configure the switching device, or similar. An example for a corresponding automatic configuration in the network is the simple service discovery protocol, which is used as part of universal plug & play.

The identification dataset describes a network address, via which the switching device may be addressed. Additionally or alternatively, the identification dataset may include information about assigned detection devices, such as the type of a detection device, for example, whether it includes a detection of pressure, temperature, current, voltage, etc., an arrangement point of the detection device, for example, an identification of the consumer, information, which parameter is detected or with which unit this parameter is detected, status information, for example, whether the assigned detection device is active or passive or whether an error exists, current detection values, or values calculated from these or similar.

After an initial identification of the switching device in the network, the detection values or the values calculated from these may be interrogated by a cyclic interrogation by the central device. Particularly advantageously however, an automatic transmission of the detection values or the values calculated from these is accomplished by the switching device.

A configuration function implemented by the switching device may be called up by the central device to adapt at least one configuration parameter relating to the detection and/or the calculation of the detection values and/or the calculation of the energy values. A scanning rate or an accuracy of the scanning for the detection values may be adapted as configuration parameter. If the energy value includes a value calculated from one or more detection values, a calculation frequency or resolution may also be adapted. A network load may be adapted by a configuration of the switching device, such as by adapting a transmitted data volume. If a transmission of energy values is not made with a fixed period but depending, for example, on the detection values, at least one limiting value may be adapted by a configuration parameter. When an energy value or a value derived from the energy value exceeds or falls below this value, a transmission takes place.

The detection values provided to the switching device may be buffered by the switching device, wherein the energy values are transmitted to the central device regularly or when fulfilling a predefined condition. The predefined condition may include a deviation from an energy value last transmitted to the central device. A regular transmission may take place taking into account an additional condition. For example, it is possible that a switching device only begins to transmit energy values after receiving a configuration and/or start call up from the central device.

Detection values or values calculated from these of one or more detection devices may be additionally grouped or ordered by the switching device. When data of a plurality of detection devices are detected by a switching device, which provide detection values with different latencies and/or different frequencies, a correct temporal assignment of the respective detection values to one another may thus be provided.

The central device and the switching device may each include internal clocks and the internal clocks may be synchronized via the network. The central device may transmit synchronization messages via the network at predefined times, for example, via the Network Time Protocol. A time value may be assigned to each of the energy values by the switching device individually or in groups and this may be transmitted jointly with the energy values to the central device. By the synchronization of the internal clocks, energy values may be assigned to specific time points with the result that it is possible to reliably create consumption profiles. On the other hand, values from the same time points may be combined when combining energy values of various central devices.

Depending on the type of transmitted energy values, it may be sufficient to achieve a relatively low accuracy of the time values or the time synchronization. For example, temperature values of gases or liquids may vary on a time scale of several seconds. If, however, as part of the energy detection a distinction is to be made between an idle and an active power and currents and voltages are transmitted separately as energy values, a relatively high time resolution of less than 10 ms is required, (e.g., for alternating currents of 50 Hz), in order to reliably determine a relative phase position of current and voltage.

It is possible that the respective energy values are transmitted by the switching device as part of a data structure, which describes the respective detection value or the respective detection values and/or the respective detection device or the respective group of detection devices. For example, XML may be used as a format for such a data structure. A data structure may include a plurality of data elements, such as a type of detection values, e.g., whether this includes a current, a pressure, a temperature, etc., a unit of the detection value such as a detection location, a consumer identification, a time stamp, and similar.

In addition to the energy management method, the disclosure relates to a switching device for an energy management device, wherein the switching device is configured for participation in the method, wherein this may be assigned to one of the detection devices and/or the group of detection devices and is configured to receive the detection values detected and/or calculated by the assigned detection device or the assigned group of detection devices according to the predefined detection-device-side protocol and transmit the respective energy values according to the predefined central-device-side protocol that differs from the detection-device-side protocol via the network to the central device.

The switching device may provide a plurality of potential detection-device-side protocols, wherein depending on the assigned detection device or the assigned group of detection devices, one of the potential detection-device-side protocols may be used as the switching-device-side protocol. The switching device may therefore be used flexibly for a plurality of detection devices, which communicate via different detection-device-side protocols.

Additionally, or alternatively, the switching device may be connected via an adapter element configured separately from the switching device to the detection device and/or the group of detection devices, wherein various adapter elements may be used and wherein the switching device may be connected depending on the adapter element used to various detection devices and/or groups of detection devices. As a result of the use of an adapter element, the switching device may be flexibly connected to a plurality of different detection devices. It is easier to integrate into existing consumer infrastructures.

In addition, the disclosure relates to an energy management device for detecting an energy consumption of a consumer connected to an energy supply network, wherein the sum of the maximum power consumptions of all the consumers is at least 5 kW, wherein the energy management device includes a plurality of detection devices, by which detection values relating to respectively one energy consumption are detected and/or calculated, a central device to which the detection values and/or values calculated from the detection values are transmitted as energy values and stored there and/or evaluated, and at least one switching device. The energy management device may be configured for executing the method.

In addition, the disclosure relates to a computer program, wherein when executing the computer program on a programmable processing device with at least one connection device for connection to a network and at least one further connection device for connection to a detection device, the processing device is configured for participating in the method as a switching device, which may be assigned to one of the detection devices and/or a group of detection devices and is configured to receive the detection values detected by the assigned detection device or the assigned group of detection devices according to the predefined detection-device-side protocol and transmit the energy values according to the predefined central-device-side protocol that differs from the detection-device-side protocol via the network to the central device.

Features disclosed in relation to the energy management method, the switching device, the energy management device, or the computer software product, insofar as they may refine the corresponding subject matter, may also be applied to the further subject matters in each case.

### BRIEF DESCRIPTION OF THE DRAWINGS

Further advantages and details are obtained from the following exemplary embodiments as well as the appurtenant drawings. In the figures, shown schematically:

FIG. 1 depicts a flow diagram of an energy management method according to an example.

FIG. 2 depicts the incorporation of an additional switching device into an energy management system as part of the energy management method according to FIG. 1.

FIG. 3 depicts an example of an energy management device.

FIG. 4 depicts the use of an energy management device according to an example in an industrial installation.

FIG. 5 depicts an example of a switching device.

### DETAILED DESCRIPTION

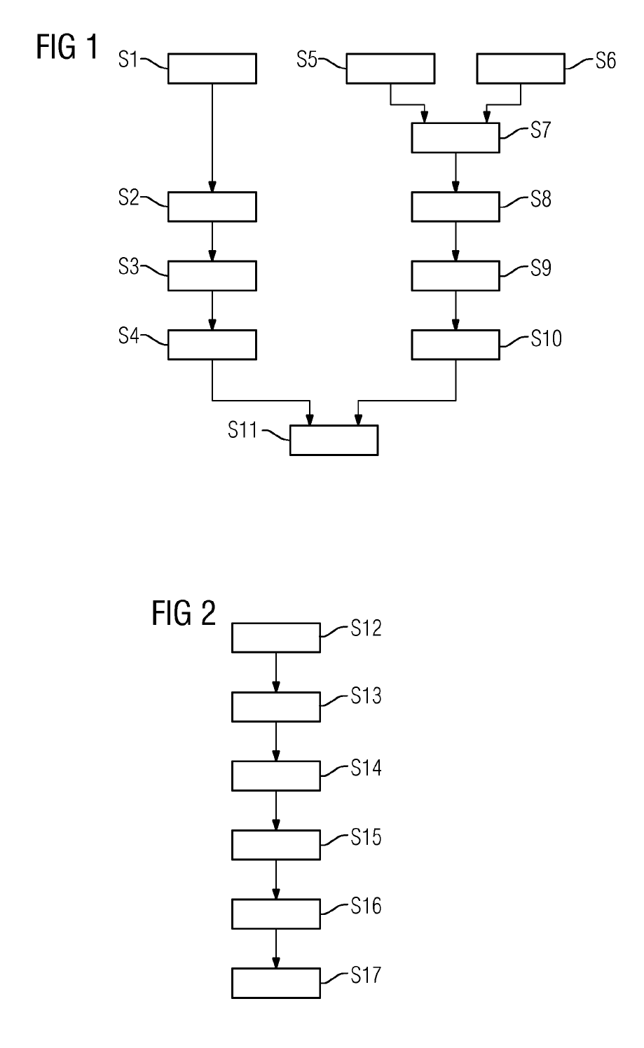

FIG. 1 depicts schematically a flow diagram of an energy management method for detecting an energy consumption of a plurality of consumers connected to an energy supply network in a building. In act S1 a detection value relating to an energy consumption is detected by a detection device. The detection value detected in act S1 includes a motor rotational speed, from which an instantaneous motor power and therefore an energy consumption is calculated in the further course of the method.

The detection value detected in act S1 is provided to a switching device in act S2 with a detection-device-side protocol. The rotational speed of the motor is provided on the detection device side as the frequency of a pulse voltage, which is applied to a signal line supplied to the switching device, e.g., the detection value corresponds to a period length.

This period length, (e.g., the transmission of the detection value according to the detection-device-side protocol), is detected by the switching device and further processed in act S3 in order to calculate a value calculated from the provided detection value. To this end, the switching device includes conversion data from a motor rotational speed to a power, e.g., to an instantaneously consumed energy. The conversion data may be set in the course of the installation of the switching device, as will be explained further for FIG. 2 and/or they may be adapted by a central device in continuous operation by calling up a configuration function of the switching device retrievable via the network.

In act S4, the energy value, (e.g., the instantaneously consumed power calculated in act S3), is transmitted to the central device. A transmission of the instantaneously consumed energy is performed periodically, wherein the period duration may be configured by calling up a configuration function implemented by the switching device by the central device. The switching to the central device is made by a central-device-side protocol, for example, BACnet, wherein the energy value is transmitted as part of a data structure, which describes the detection value in detail. The data structure may be constructed according to the XML standard. The data structure includes a plurality of fields, which specify that the detection value includes an instantaneous energy consumption of a motor and which includes an unambiguous identification for the motor and a time stamp for the instantaneous energy value. The time stamp specifies a detection time point for the detection value, from which the energy value was calculated. To confirm that the time stamps of several switching devices are comparable, the internal clocks of the switching devices and the central device are synchronized via the network, whereby the central device sends synchronization messages via the network in parallel with the method shown, which are received by the switching devices.

Acts S5 to S10 are executed in parallel with acts S1 to S4, in which further energy values are determined and sent to the central device. To this end, a detection device is used, which calculates a detection value from measured values of a plurality of sensors.

In act S5, a voltage value is detected as measured value. In act S6, a current measured value is detected as measured value, from which in act S7, a power is calculated as calculated detection value. When a power is detected as detection value and current and voltage values are measured, it may be advantageous to perform the power calculation beforehand in the detection device itself, because even small run-time differences of a few milliseconds between the measured signals may falsify the calculation of an active power.

The calculated detection value is transmitted to another switching device in act S8. The communication between the detection device and the additional switching device is made via another detection-device-side protocol, for example, Modbus.

In act S9, the detection values transmitted in act S8 are buffered and the current received detection value is compared with that detection value, which was last transmitted as energy value to the central device. If the magnitude of the difference falls below a predefined limiting value, the newly received detection value is not transmitted to the central device to unburden the network. However, if a corresponding limiting value is exceeded, in act S10, as already explained for act S4, the detection value is transmitted as energy value to the central device.

The energy values transmitted in acts S4 and S10 are received by the central device in act S11 and stored. They may then be evaluated and/or provided to additional devices for further processing and/or displayed (when suitably prepared).

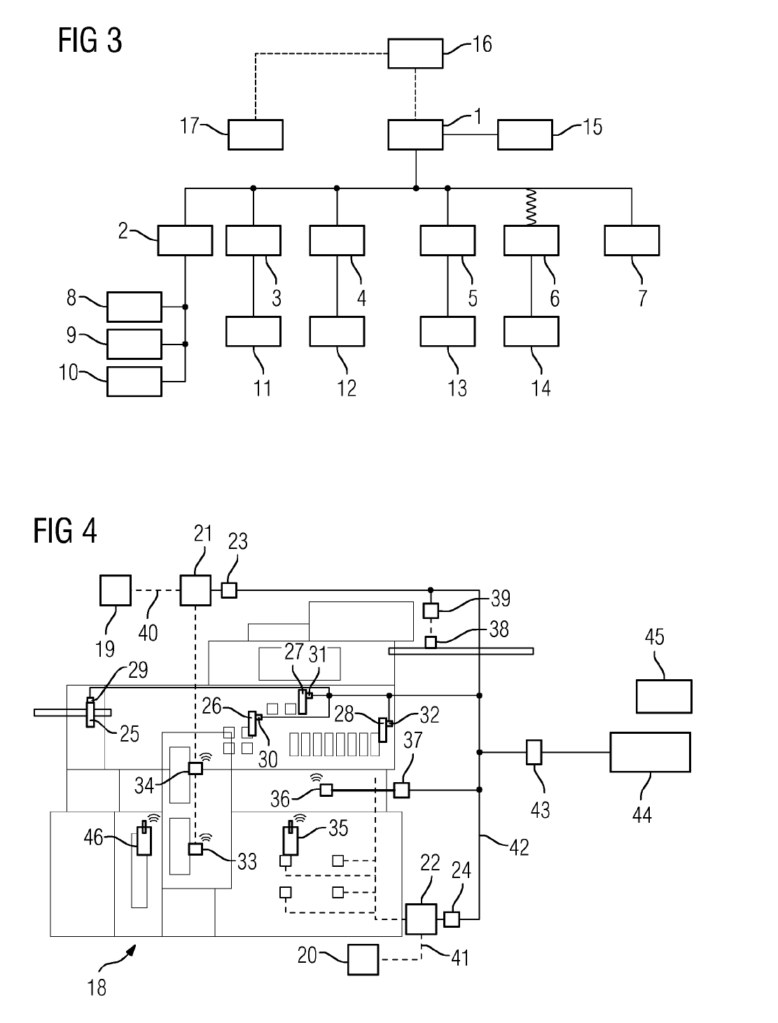

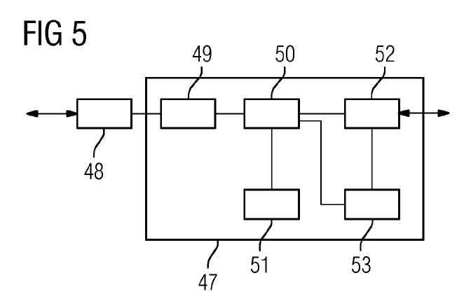

The energy management method described may obviously be extended to provide additional switching devices to which additional detection devices are assigned. As will be explained in detail with reference to FIG. 3 and FIG. 4, a plurality of detection devices may be assigned to a single switching device, which in particular use a common detection-device-side protocol for communication with the switching device. In addition, values not determined from a measured value may also be detected as detection values. For example, detection values determined merely as a function of control parameters, (e.g., by simulation), may be detected by a detection device.

FIG. 2 depicts the acts executed in the described energy management method when a new switching device with assigned measuring devices is to be integrated in the method. The acts shown may be executed in parallel with the acts depicted in FIG. 1, but it is also possible to interrupt the execution of the acts depicted in FIG. 1 while the acts depicted in FIG. 2 are executed. In act S12, initially a first configuration of the switching device takes place, while this is in particular still separated from the network, which connects the central device to the additional switching devices. As part of the first configuration of the switching device, in particular additional information about those detection devices, which are assigned to the switching device, is stored in a nonvolatile memory of the switching device. Conversion factors, functions or tables between detection values provided by the detection devices and to be transmitted may be specified and identification information may be assigned to the individual assigned detection devices.

In act S13, the switching device is connected to at least one detection device and the network connecting the switching devices to the central device. The connection to the detection device is made, in particular, via an adapter element. For example, a USB connection or similar may be provided to the switching device, to which an adapter element may be connected, which enables a mechanical and electrical connection to the detection device. A direct connection of the switching device to the detection device is also possible via a switching-side connection. Alternatively, it would be possible to connect the switching device in a cableless manner to the detection device and/or the central device.

In act S14, it is identified that a new switching device has been connected to the network. To identify newly connected switching devices, the central device sends an identification request at specific times, not necessarily regular times, as a broadcast, (e.g., as a message). The identification request is received by all network participants into the network. The sent identification request calls up in act S15 an identification function implemented in each case by the switching devices. This function provides an identification dataset to the central device. This includes information describing the respective switching device and the detection device assigned to the switching device or the group of detection devices assigned to the switching device. In particular, the information predefined in act S12 in the course of the configuration is transmitted at least partially as part of the identification dataset.

As a result of the received identification datasets, the central device identifies the presence of the new switching device and in act S16 sends a configuration request to the newly connected switching device in order to adapt configuration parameters of the switching device, in particular a scanning rate and an accuracy or resolution of the scanning of the detection values in the course of a second configuration. This request is received by the switching device in act S17, with the result that a switching-device-side implemented configuration function is called up to adapt the parameters of the switching device. After the configuration of the switching device by the central device, the switching device may start automatic transmission operation, in which detection values or values calculated from the detection values are sent to the central device as energy values regularly or when certain conditions are satisfied. Alternatively, it would be possible to start automatic transmission operation only upon receiving a start signal from the central device or to interrogate the detection values in each case by the central device.

As a result of the procedure described, it is achieved that in the explained energy management method, additional detection devices and additional switching devices may be simply added to an existing system with low configuration expenditure. The procedure described with reference to FIG. 2 may also be used to reconstruct an energy management device and connect one or several switching devices to a central device and the associated detection devices.

FIG. 3 depicts an exemplary embodiment of an energy management device for detecting an energy consumption of several consumers arranged in a building and connected to an energy supply network. The energy management device includes a central device 1, which is connected via a central-device-side network to the switching devices 2, 3, 4, 5, and 6. The connection to the switching devices 2, 3, 4, and 5 is made in a wired manner via Ethernet, the connection to the switching device 6 is made in a wireless manner via WLAN. The detection device 7, which communicates directly with the central device, is additionally connected to the network, which connects the central device 1 to the switching devices 2, 3, 4, 5, 6.

The communication in the network, which connects the central device 1 to the switching devices 2, 3, 4, 5, 6 and the detection device 7, is made via the OPC unified architecture (OPC UA). The switching devices 2, 3, 4, 5, 6 as well as the detection device 7 are defined in this protocol as objects, which have certain properties and usable functions. Such an object may include a digital value as property, which represents the energy value. The central device may thus directly read out the respectively prepared energy values or the switching devices may be configured in such a manner that the energy values are automatically transmitted via the network. Alternatively, for example, BACnet, a network protocol for building automation systems, may be used in this network.

The switching devices 2, 3, 4, 5, 6 are each assigned one or several detection devices 8, 9, 10, 11, 12, 13, 14, with which communication is made in each case via a detection-device-side protocol. The detection devices 8, 9, 10 are measuring devices and each provide measured values for voltages and currents to an output of a current converter. The communication between the switching device 2 and the detection devices 8, 9, 10 is made via Modbus.

The detection device 11 is a machine controller, which provides a calculated detection value to the switching device 3 depending on control parameters of the machine. The communication between the switching device 3 and the detection device 11 is made via a network connection for remotely retrievable functions, (e.g., SOAP).

The detection device 12 provides a motor rotational speed in the form of a pulsed voltage, wherein the frequency of the voltage pulses correlates with the rotational speed. The detection-device-side protocol thus corresponds to the agreement to transmit rotational speeds by sequences of voltage pulses. As explained for FIG. 1, an energy value is determined from this pulse sequence by the switching device 4 and provided via the network to the central device 1.

The detection devices 13 and 14, the switching devices 5 and 6, and the central device 1 cooperate to determine a transported power in a line for hot steam. A flowmeter is arranged in the steam line as detection device 13, which provides an analog voltage proportional to the flow to the switching device 5. This digitizes the analog voltage, scales the digital values according to stored calibrating information, and provides a flow value as energy information to the central device 1.

The temperature of the gas flow is detected by a temperature sensor, (the detection device 14), and the temperature values are provided as detection values via a I2C protocol to the switching device 6. This transmits the detection values as energy values via a WLAN connection and the OPC-UA protocol to the central device 1. Thus, flow measurements and temperature measurements are available to the central device 1.

Because both these measures are transmitted by the switching device 5, 6 jointly with a time stamp, measured values of the detection devices 13 and 14 assigned temporally to one another may be used to determine a power flow from the flow and the temperature.

The central device 1 is an industrial computer arranged locally in the building, which stores the received energy values and provides them to the additional devices 15, 16 for further processing. The device 15 is a processing device, which is connected via a local network and enables a local monitoring of the energy consumption. The processing device 16 is a processing device of an external service provider, which is connected to the central device 1 via a virtual private network via the Internet. Medium- and long-term evaluations of the energy consumption may be performed on the processing device 16 and the results of these evaluations may be provided via the Internet to an additional processing device 17, for example, as a report.

FIG. 4 depicts the use of an energy management device in an industrial installation in a building 18. The power supply to the industrial installation is made via two feeds 19, 20, which provide energy to a plurality of consumers arranged in the building via the power lines 40, 41. The feeds 19, 20 are each assigned detection devices 21, 22, which detect an energy consumption via the respective power line 40, 41 and provide the detection values via the Modbus protocol. For communicating the detection values to the central device 43, an industrial PC, the switching devices 23, 24 are provided which, as explained for FIGS. 1 and 3, perform a protocol conversion and provide the detection values as energy values to the central device 43.

OPC unified architecture is used as central-device-side protocol in the network 42 in order to configure the switching devices 23, 24 and the further switching devices 29, 30, 31, 32, 37, 39 addressably as objects, whose properties may be read out and changed via the network 42.

The detection device 25 that detects a flow of a compressed air line, and the detections devices 26, 27, 28 that each detect the energy consumption of a group of consumers, are each assigned the switching devices 29, 30, 31, 32, which via an arbitrary detection-device-side protocol in each case, (e.g., I2C), detect detection values and provide these as energy values via the network 42 to the central device 43. The detection device 38, which detects a water flow, communicates via a HART protocol with a field bus as communication infrastructure with the switching device 39, which provides detection values of the detection device 38 via the network 42 to the central device 43.

The detection device 33, which detects an energy consumption of a cooling system, the detection device 34, which detects the energy consumption of an air extraction system, and the detection devices 35, 46, which each detect a power consumption of various devices, communicate via a wireless HART interface with the wireless communication device 36. The wireless communication device 36 provides the detection values detected in a wireless manner by the detection devices 33, 34, 35, 46 via a detection-device-side protocol predefined by the communication device 36 to the switching device 37, which provides this or values calculated therefrom in turn as energy values via the network 42 to the central device 43.

The central device 43 stores the received energy values and provides a time profile of the detected energy values to an external server 44, by which a data evaluation may be made. The provided energy data and/or evaluation data may be accessed via client systems 45. Advantageously energy data of a plurality of industrial installations may be collected and processed by the server 44.

FIG. 5 depicts an exemplary embodiment of a switching device for a previously described energy management device. To enable a flexible connection to a plurality of different detection devices, the switching device 47 may be connected via an adapter element 48 to the respective detection device or group of detection devices. The adapter element 48 is connected by a detection-device-side connecting device 49 to the switching device 47. The detection-device-side connecting device 49 may include a connection of a USB bus. For the sake of clarity, only one detection-device-side connecting device 49 is shown. Advantageously, the detection device 47 includes a plurality of various detection-device-side connecting devices 49, with the result that an adapter element 48 may be dispensed with in the connection to some of the detection elements. For example, the switching device 47 as further detection-device-side connecting device may have connections, which are fed to an analog-digital converter or support alternative forms of a serial or a parallel connection.

The data received via the detection-device-side connecting devices 49 are processed by a processor 50 with assigned memory 51. For this purpose, a computer software product is executed on the switching device 47, which provides the functionalities for detecting and processing detection values and for providing the detection values or the values calculated from these as energy values.

For flexible integration in a network, which connects the central device to the switching devices, the switching device 47 has two different possibilities for a network connection. On the one hand, a cabled network connection, (e.g., an Ethernet interface), is provided as connection device 52 for connection to a network. On the other hand, the switching device 47 includes as connection device 53 for connection to a network in order to be integrable in cableless networks.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. An energy management method for detecting an energy consumption of at least one consumer connected to an energy supply network, the method comprising:
detecting and/or calculating, by a plurality of detection devices, detection values relating to the energy consumption for the at least one consumer;
assigning at least one detection device, at least one group of detection devices, or the at least one detection device and the at least one group of detection devices to a respective switching device;
providing the detection values to the respective switching device according to a detection-device-side protocol predefined for the at least one detection device, the at least one group of detection devices, or the at least one detection device and the at least one group of detection devices;
transmitting at least parts of the detection values and/or values calculated from at least parts of the detection values as energy values to the central device via a network connecting the central device to all the switching devices, according to a predefined central-device-side protocol that differs from a detection-device-side protocol.

2. The energy management method of claim 1, wherein the switching device is exclusively used for:
receiving the detection values, calculating the values calculated from the detection values, or receiving the detection values and calculating the values; and
transmitting the respective energy values to the central device.

3. The energy management method of claim 1, wherein at least two switching devices are used, to which the detection values with detection-device-side protocols are provided that are different from one another.

4. The energy management method of claim 1, wherein functions retrievable via the network are implemented by the central device, the switching device, or both the central device and the switching device.

5. The energy management method of claim 4, wherein an identification request is transmitted to all switching devices connected to the network by the central device at predefined times,
wherein an identification function implemented by the respective switching device is executed by which an identification dataset describing the respective switching device and/or the detection device or group of detection devices assigned to the respective switching device is transmitted to the central device.

6. The energy management method of claim 4, wherein a configuration function implemented by the switching device is called up by the central device to adapt at least one configuration parameter relating to one or more of the detection, the calculation of the detection values, or the calculation of the energy values.

7. The energy management method of claim 6, wherein a scanning rate or an accuracy of the scanning for the detection values is adapted as a configuration parameter.

8. The energy management method of claim 1, wherein the detection values provided to the switching device are buffered by the switching device,
wherein the energy values are transmitted to the central device regularly or upon fulfilling a predefined condition.

9. The energy management method of claim 1, wherein the central device and the switching device each comprise internal clocks, and
wherein the internal clocks are synchronized via the network.

10. The energy management method of claim 1, wherein the respective energy values are transmitted by the switching device as part of a data structure,
wherein the data structure describes the respective detection value or the respective detection values, and/or the respective detection device or the respective group of detection devices.

11. A switching device for an energy management device, the switching device configured to:
receive detection values by an assigned detection device or an assigned group of detection devices; and
transmit energy values, according to a predefined central-device-side protocol that differs from a detection-device-side protocol, to a central device via a network connecting the central device to the switching device.

12. The switching device of claim 11, wherein the switching device provides a plurality of potential detection-device-side protocols, and
wherein a potential detection-device-side protocol of the plurality of potential detection-device-side protocols is configured to be used as the detection-device-side protocol depending on the assigned detection device or the assigned group of detection devices.

13. The switching device of claim 11, wherein the switching device is connected via an adapter element configured separately from the switching device to the detection device and/or the group of detection devices,
wherein various adapter elements are configured to be used, and
wherein the switching device is connected, depending on the adapter element used, to various detection devices and/or groups of detection devices.

14. An energy management device for detecting an energy consumption of a consumer connected to an energy supply network, the energy management device comprising:
a plurality of detection devices, by which detection values relating to respectively one energy consumption are detected and/or calculated;
at least one switching device configured to receive detection values by an assigned detection device or an assigned group of detection devices, and transmit the energy values according to a predefined central-device-side protocol that differs from a detection-device-side protocol; and
a central device configured to receive the transmitted energy values from the at least one switching device via a network connecting the central device and the at least one switching device, and store and/or evaluate the energy values.

15. (canceled)

16. A computer program configured to be stored on a switching device, wherein the computer program is configured to cause the switching device to at least perform:
receive detection values by an assigned detection device or an assigned group of detection devices; and
transmit energy values, according to a predefined central-device-side protocol that differs from a detection-device-side protocol, to a central device via a network connecting the central device to the switching device.
